(19) United States
(12) Patent Application Publication
(10) Pub. No.: US 2017/0175621 A1
(43) Pub. Date: Jun. 22, 2017

(54) ENGINE OPERABLE IN HORIZONTAL AND VERTICAL SHAFT ORIENTATIONS

(71) Applicant: Briggs & Stratton Corporation, Wauwatosa, WI (US)

(72) Inventor: Jerry Schenkel, Pewaukee, WI (US)

(73) Assignee: Briggs & Stratton Corporation, Wauwatosa, WI (US)

(21) Appl. No.: 14/975,037

(22) Filed: Dec. 18, 2015

(51) Int. Cl. F02B 75/00; F02D 31/00; F01M 11/04; F02F 7/00; F01P 1/02

(52) U.S. Cl. CPC F02B 75/007; F02F 7/0004; F01P 1/02; F01M 11/0458; F02D 31/001; F02F 2200/06

(57) ABSTRACT

A small air-cooled internal combustion engine includes an aluminum engine block including a cylinder, a crankcase reservoir, and an outer surface, a piston positioned within the cylinder and configured to reciprocate within the cylinder, and a crankshaft coupled to the piston and configured to rotate about a crankshaft axis, wherein a portion of the crankshaft is located in the crankcase reservoir, where the outer surface of the engine block has an edge located a radial distance from the crankshaft axis and the radial distance is less than less than a standard minimum distance between the crankshaft axis and a horizontal mounting surface for a standard garden mounting flange for a horizontally-shafted engine.

### BACKGROUND

The present invention relates generally to the field of small air-cooled internal combustion engines, and particularly to the field of engine blocks for small air-cooled internal combustion engines.

### SUMMARY

One embodiment of the invention relates to a small air-cooled internal combustion engine including an aluminum engine block including a cylinder, a crankcase reservoir, and an outer surface, a piston positioned within the cylinder and configured to reciprocate within the cylinder, and a crankshaft coupled to the piston and configured to rotate about a crankshaft axis, wherein a portion of the crankshaft is located in the crankcase reservoir, where the outer surface of the engine block has an edge located a radial distance from the crankshaft axis and the radial distance is less than less than a standard minimum distance between the crankshaft axis and a horizontal mounting surface for a standard garden mounting flange for a horizontally-shafted engine.

Another embodiment of the invention relates to a small air-cooled internal combustion engine including an aluminum engine block including a cylinder and a crankcase reservoir, wherein the engine block does not include a lubricant inlet that allows a user to add lubricant to the crankcase reservoir, a piston positioned within the cylinder and configured to reciprocate within the cylinder, and a crankshaft coupled to the piston and configured to rotate about a crankshaft axis, wherein a portion of the crankshaft is located in the crankcase reservoir.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures.

FIG. 1 is an exploded perspective view of a standard small air-cooled engine, according to an exemplary embodiment.

FIG. 2 is a front elevation view of an engine, according to an exemplary embodiment

FIGS. 3A and 3B are rear elevation views of the engine of FIG. 2 with the crankcase cover removed.

FIG. 4 is an exploded perspective view of the engine of FIG. 2 and a cylinder head.

FIG. 5 is a perspective view from above of the cylinder head of FIG. 4.

FIG. 6 is a perspective view from below of the cylinder head of FIG. 4.

FIG. 7 is a schematic representation of an electronic governor system according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Small air-cooled engines are typically manufactured for use as either vertical shaft engines in which the engine's crankshaft is arranged vertically when the engine is in its normal operating or working position or as horizontal shaft engines in which the engine's crankshaft is arranged horizontally in its normal operating or working position. Small engines used for lawn and garden equipment are typically mounted to the equipment powered by the engine with a garden mounting flange having industry standard dimensions. To accommodate these industry standard mounting flange dimensions, the geometries of the structural components of the engine (i.e., the engine block, cylinder, or crankcase cover) have had to be different for vertically-shafted engines than for horizontally-shafted engines. This is because the physical arrangement of the geometries of the standard garden mounting flange for a horizontally-shafted engine and the structural components of a vertically-shafted engine do not allow the mounting flange to be properly attached to the engine.

Changing the engine crankshaft orientation has also required changes in other components of the engine, particularly in the arrangement of the engine's lubrication system, including the oil sump (crankcase reservoir), the components that define the oil sump, which may include the engine block and the crankcase cover, the location of the oil inlet or fill tube for adding oil to the oil sump, the location of the dip stick for measuring the amount of oil in the oil sump, and the mechanism for distributing oil within the oil sump (e.g., an oil slinger, an oil pump), and/or different governors. Engine manufacturing would be simplified and could more rapidly respond to changes in customer needs if the same basic engine model could be used as either a vertical shaft engine or a horizontal shaft engine without having to change components of the engine to switch between shaft orientations or by only having to make minor changes non-structural components of the engine (i.e., not the engine block, cylinder, or crankcase cover). For example, such minor changes could include changing the orientation of the carburetor or selecting a connecting rod, oil slinger, or other internal component of the engine optimized for use in either a vertical shaft or a horizontal shaft orientation.

Advances in aluminum forming (e.g., casting, die casting, etc.) and welding (e.g., laser welding) allow structural components of an aluminum engine to be secured to one another without the use of mechanical fasteners (e.g., bolts) and avoid the shortcomings associated with such fasteners (e.g., providing robust mounting locations, distortion due to the torque required to secure the fasteners, the need for gaskets between components being secured to one another, etc.). These advances allow for a substantially sealed engine that does not require a user to add or change the oil of the engine. This allows components related to adding and changing oil (e.g., the oil inlet or fill tube, the dip stick, an oil drain) to be eliminated from the engine.

The small air-cooled engine described herein includes an engine block and crankcase cover that allow vertically-shafted and horizontally-shafted engines to share the same structural components. The engine is substantially sealed and eliminates components related to adding and changing oil. The engine also uses an electronic governor instead of a mechanical governor. Eliminating the mechanical governor, which is typically found within the oil sump, allows for a reduction in volume of the oil sump sufficient to change the geometry of the structural components of the engine so that the engine can be properly attached to either a standard garden mounting flange for a vertically-shafted engine or a standard garden mounting flange for a horizontally-shafted engine.

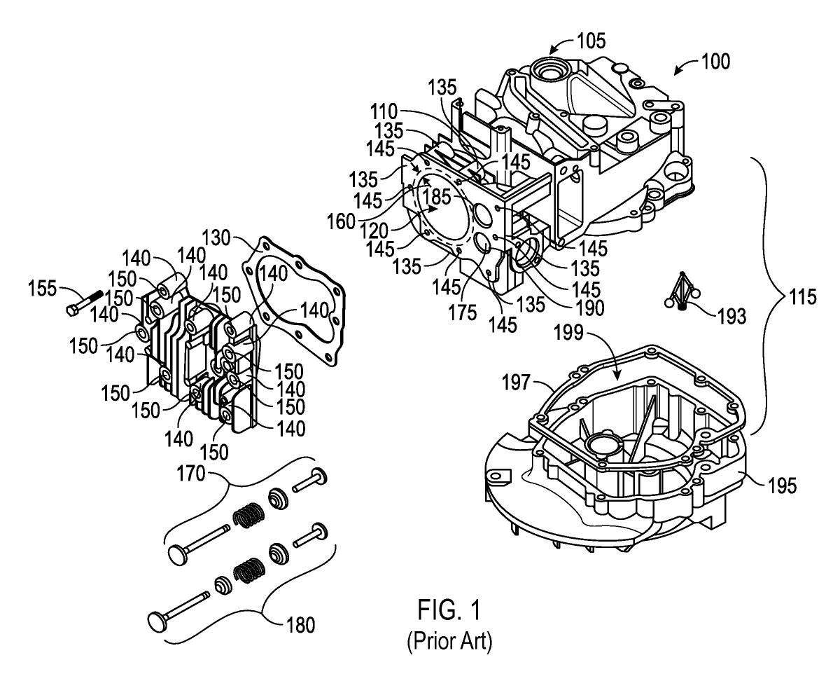

Referring to FIG. 1, a standard small air-cooled engine 100 is illustrated. The engine 100 includes an engine block 105 having a cylinder block 110 and a crankcase 115. The cylinder block 110 includes one or more cylinder bores 120, each receiving a piston. A cylinder head 125 is fastened to the cylinder block 110 above the cylinder bore 120 to close the cylinder bore 120. A head gasket 130 is positioned between the cylinder head 125 and the cylinder block 110 to seal the connection between the cylinder block 110 and the cylinder head 125. The cylinder block 110 and the cylinder head 125 each include multiple mounting locations or bosses 135, 140 positioned around the cylinder bore 120. A mounting aperture or opening 145, 150 is formed through each of the mounting locations 135, 140, respectively, and a bolt 155 is inserted through each pair of apertures 145, 150 to secure the cylinder head 125 to the cylinder block 110. As shown in FIG. 1, four bolts 155 are used to secure the cylinder head 125 to the cylinder block 110. The mounting apertures 145, 150 are located outside of a cylinder wall thickness 160. The cylinder wall thickness 160 is substantially constant for the length of the cylinder bore 120. Cooling fins may extend from the outer surface of the cylinder wall.

The cylinder block 110 also includes an intake port 165 in which an intake valve 170 is positioned and an exhaust port 175 in which an exhaust valve 180 is positioned. A valve seat 185, 190 is press fit to the cylinder block 110 around an aperture (e.g., opening) to each of the intake port 165 and the exhaust port 175.

The crankcase 115 houses the crankshaft to which the piston is coupled and also acts as a reservoir for lubricant (e.g., oil) for the internal components of the engine 100. The crankcase 115 includes a crankcase cover or sump 195 that is fastened to the engine block 105 to close the crankcase 115 (e.g., with multiple bolts). A lubricant inlet is provided to allow a user to add lubricant to the lubricant reservoir. A dipstick may be provided to allow a user to measure the lubricant level within the lubricant reservoir. The crankcase cover 195 is removable to provide access to the internal components of the engine 100. A crankcase gasket 197 is positioned between the cylinder block 110 and the crankcase cover 195 to seal the connection between the cylinder block 110 and the crankcase cover 195. A mechanical governor 193 is positioned within the oil sump or reservoir 199 formed by the cylinder block 110 and the crankcase cover 195.

The connections between the cylinder block 110 and the cylinder head 125 and between the engine block 105 and the crankcase cover 195 provide locations for possible leaks (e.g., of air, fuel-air mixture, oil, etc.) into or out of the engine block 105. Also, the locations at or near these connections, particularly between the cylinder block 110 and the cylinder head 125 (e.g., at the mounting locations 135, 140) require a substantial mass of material in order to make the connection. The substantial mass is necessary to minimize potential adverse effects of the clamping force needed to secure the cylinder head 125 to the cylinder bock 110. The shape and mass of the material used in the mounting locations 135, 140 is, at least in part, determined by the need to minimize or control the amount of distortion caused to the cylinder bore 120 when the cylinder head 125 is bolted to the cylinder block 110. Such distortion (e.g., of the roundness and/or eccentricity of the cylinder bore 120) can result in leaks into or out of the cylinder bore 120 (e.g., to or from the crankcase 115).

The substantial mass of the mounting locations 135, 140 also can cause failure modes related to heat transfer at these locations. For example, thermal expansion at and near the mounting locations 135, 140 and the sealing surfaces of the cylinder block 110 and the cylinder head 125 during use of the engine 100 and the subsequent cooling of these areas when the engine 100 is stopped may result in a reduced clamping force between the cylinder block 110 and the cylinder head 125 (e.g., due to stretched bolts 155 causing a “loose” cylinder head 125). This reduced clamping force may result in the head gasket 130 being unable to maintain a good seal and allowing leaks past the head gasket 130. Air leaks into the cylinder bore 120 increase combustion gas temperatures, which may cause the engine 100 to overheat. In some cases, the overheating may cause distortion of the cylinder block 110 (e.g., of the cylinder bore 120). As another example, difficulty in cooling the substantial mass of the mounting locations 135, 140 and/or the locations around the valves 170, 180 may result in distortion of the cylinder bore 120 and/or loosening or dislodging a valve seat insert due to excessive temperature variations. When the engine 100 is running hotter than normal engine temperatures, the cylinder bore 120 expands and may distort (e.g., near the exhaust valves). Distortion of the cylinder bore 120 may prevent the piston rings from forming a proper seal, thereby providing combustion gases a path to the crankcase. Distortion of the cylinder bore 120 near a valve 170, 180 may cause the valve seat 185, 190 to loosen or dislodge due to differences between thermal expansion of the portion of the cylinder block 110 surrounding the valve seat and of the valve seat 185, 190 itself.

Eliminating bolted connections or other fastened connections between the cylinder block 110 and the cylinder head 125 and between the engine block 105 and the crankcase cover 195 would help to reduce failure modes related to clamping forces, thermal expansion, and leaks between these components and allow reduction in the substantial mass of material needed at these locations to allow for bolted connections. Welded connections between the cylinder block 110 and the cylinder head 125 and between the engine block 105 and the crankcase cover 195 would help to reduce the shortcomings of the bolted connections. However, aluminum, which is a preferred material for engine blocks, cylinder heads, and crankcase covers, can be difficult to weld.

Advances in aluminum die-casting allow for die-cast engine blocks, cylinder heads, and crankcase covers having material properties suitable for welding. In particular, the hydrogen gas porosity of the aluminum must be reduced in order to allow welding. In some embodiments, aluminum (e.g., die-cast aluminum) is capable of being welded when the gas porosity of the cast aluminum is 0.30 milliliters per 100 grams of aluminum or less. In other embodiments, gas porosity of the cast aluminum is 0.15 milliliters per 100 grams of aluminum or less. Using the E505 ASTM standard for casting priority, levels 1 or 2 are preferred, with level 4 also likely to be acceptable. Level 5 is not believed to be acceptable.

Gas porosity can be reduced by melting the aluminum covered by an inert gas, in an environment of low-solubility gases (e.g., argon, carbon dioxide, etc.) or under a flux that prevents contact between the aluminum and air. Gas porosity can be reduced in several ways during the casting process. Turbulence from pouring the liquid aluminum into a mold can introduce gases into the molten aluminum, so the mold may be designed to minimize such turbulence. Advances in electronic control of the casting process, particularly for die casting, allow for relatively slow injection of molten aluminum into the die and finite control of the injection process, which results in cast aluminum having relatively low levels of gas porosity. Additionally, various vacuum die-casting techniques in which a vacuum is drawn in the mold prior to and/or during injection of the molten aluminum into the mold may result in cast aluminum having relatively low levels of porosity.

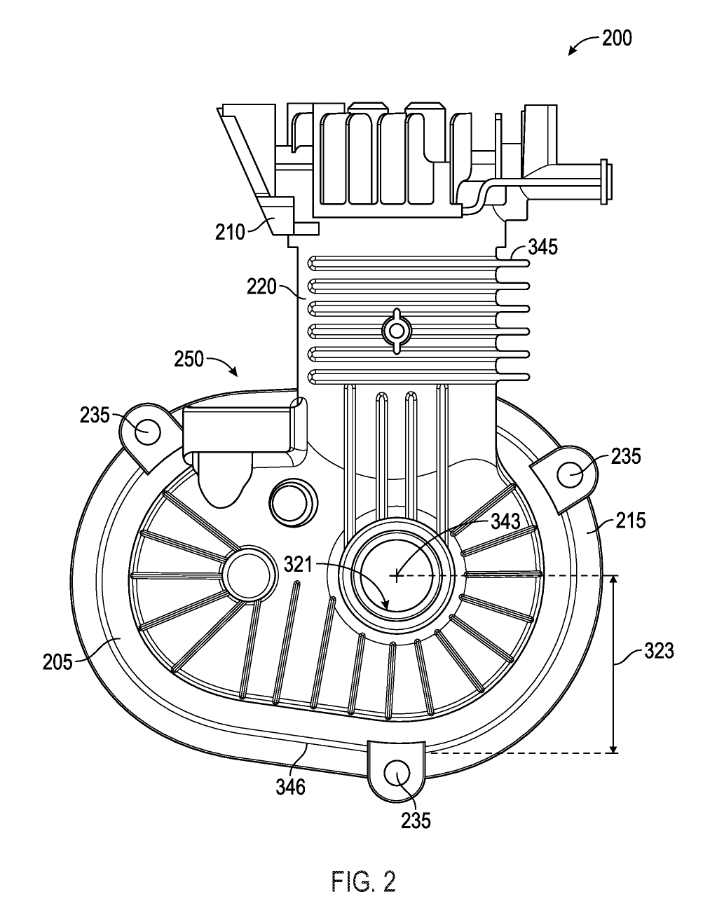

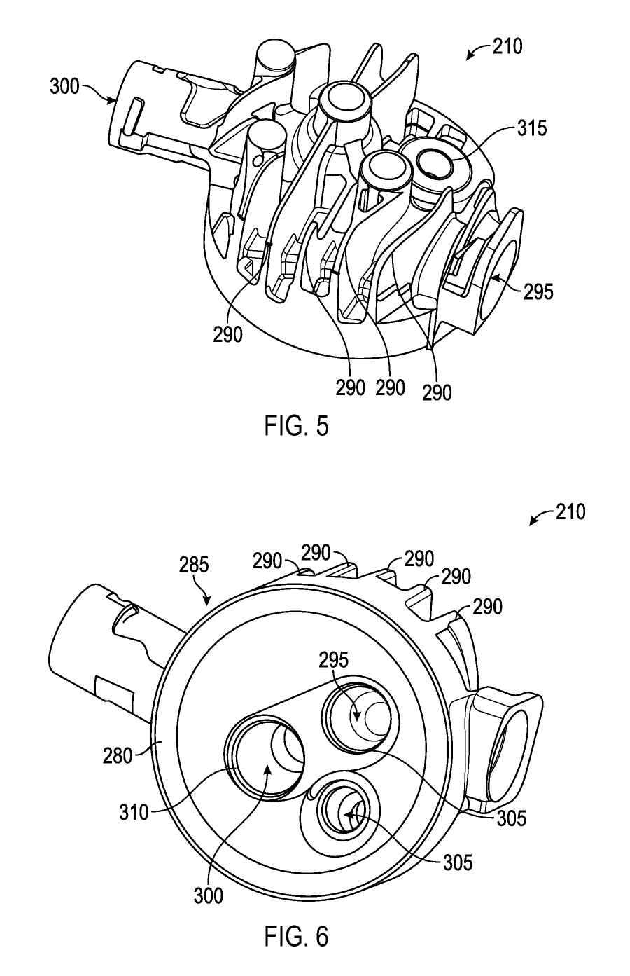

Referring to FIGS. 2-6, structural components of a small air-cooled internal combustion engine 200 that be used in either a vertically-shafted orientation or a horizontally-shafted orientation are illustrated. According to an exemplary embodiment, the engine 200 is a single-cylinder, air-cooled, four-stroke-cycle engine. However, in other embodiments, the engine may have other configurations. For example, the engine may have two or more cylinders; the engine may have a slant bore; or the engine may have a V configuration, or other appropriate cylinder configuration. The engine 200 may be configured for driving outdoor power equipment or for other purposes. Outdoor power equipment includes lawn mowers, riding tractors, snow throwers, pressure washers, portable generators, tillers, log splitters, zero-turn radius mowers, walk-behind mowers, riding mowers, industrial vehicles such as forklifts, utility vehicles, etc. Outdoor power equipment may, for example, use an internal combustion engine to drive an implement, such as a rotary blade of a lawn mower, a pump of a pressure washer, the auger of a snowthrower, the alternator of a generator, and/or a drivetrain of the outdoor power equipment.

The engine 200 includes an engine block 205, a cylinder head 210, and a crankcase cover 215. The cylinder head 210 is welded to the engine block 205 and the crankcase cover 215 is welded to the engine block 205. In some embodiments, these components are laser welded to one another. In other embodiments, these components are friction-stir welded to one another. In other embodiments, these components are MIG or TIG welded to one another. In other some, the crankcase cover 215 is welded to the engine block 205 and the cylinder head 210 is welded to the engine block 205. In other embodiments, the crankcase cover 215 is welded to the engine block 205 and the cylinder head 210 is fastened to the engine block 205 by other means (e.g., bolted, fastened by adhesive, etc.).

Welding these connections eliminates the possible leak points at these connections. Eliminating these possible leak points results in the engine 200 consuming less oil and operating at a lower oil temperature than standard small air-cooled engines. The welded connections between the cylinder head 210 and the engine block 205 and between the crankcase cover 215 and the engine block 205 may be similar to those described in U.S. Utility patent application Ser. No. 14/569,020, filed Dec. 12, 2014, which is incorporated herein by reference in its entirety.

The engine block 205 includes a cylinder block 220. The cylinder block 220 includes one or more cylinder bores 225, each receiving a piston 320. A cylinder wall 230 has a cylinder wall thickness. In some embodiments, the cylinder wall thickness is substantially constant. An end face or mounting surface 240 of the cylinder block 220 is configured to mate with (e.g., engage, abut) the cylinder head 210 so that the cylinder head 210 may be welded to the cylinder block 220. One or more cooling fins 245 extend from the outer surface of the cylinder wall 230. In some embodiments, the cooling fins 245 surround all 360° of the cylinder wall 230. In other embodiments, the cooling fins cover less than 360° of the cylinder wall 230 (e.g., 330°, 315°, 300°, 270°, etc.). The crankcase cover 215 includes apertures 235 configured to receive a threaded fastener to couple the engine 200 to the equipment powered by the engine via a standard garden mounting flange. A mounting bracket may be attached to the apertures 235 to mount the engine to a standard garden mounting flange for a horizontally-shafted engine.

The piston 320 is coupled to a crankshaft 325 with a connecting rod 330 to convert translation of the piston 118 to rotation of the crankshaft 325. A crankshaft opening or aperture 321 is formed through the engine block 205 to allow the crankshaft 325 to pass through the engine block 205. The engine 200 may include a camshaft 340 driven by a geared connection between a camgear 345 and a timing gear coupled to the crankshaft 325. In some embodiments, the camshaft 340 drives push rods to operate intake and exhaust valves that direct fuel and air flow through the combustion chamber, where combustion processes interact with the piston 320. Two push rod openings 250 are formed in the engine block 205 to allow each push rod to extend from the camshaft to a rocker arm. A push rod housing may be secured and sealed to the engine block 205. The push rod housing surrounds and protects the push rods. In some embodiments, the push rod housing is formed of plastic with overmolded gaskets (e.g., rubber gaskets) at the connection points between the housing and the engine block 205 and the valve cover. In some embodiments, the gaskets are formed in other appropriate ways and/or from other appropriate materials.

According to an exemplary embodiment, as the piston 320 translates back and forth, the connecting rod 330 rotates the crankshaft 325. Counterweights (e.g., counterbalances) 350, reduce wobble of the crankshaft 325 as the connecting rod 330 drives the crank throw (e.g., a measure of the distance the piston 320 and connecting rod 330 travel). The internal volume of the engine block 205 is sized to allow the piston 320 to translate and for the crankshaft 325, the camshaft 340, and the camgear 345 to rotate freely.

Oil is collected inside an oil sump or reservoir 347 formed by the engine block 205 and the crankcase cover 215 for distribution within the engine to lubricate moving components, including the piston 320, the crankshaft 325, the camshaft 340, and the camgear 345. The engine 200 does not include a mechanical governor positioned within the oil reservoir 347 and instead includes an electronic governor 400. Eliminating the mechanical governor allows for a reduction in volume of the oil reservoir 347 as compared to engines including a mechanical governor (e.g., the engine 100 described above). This reduction in volume changes the geometry of the engine block 205.

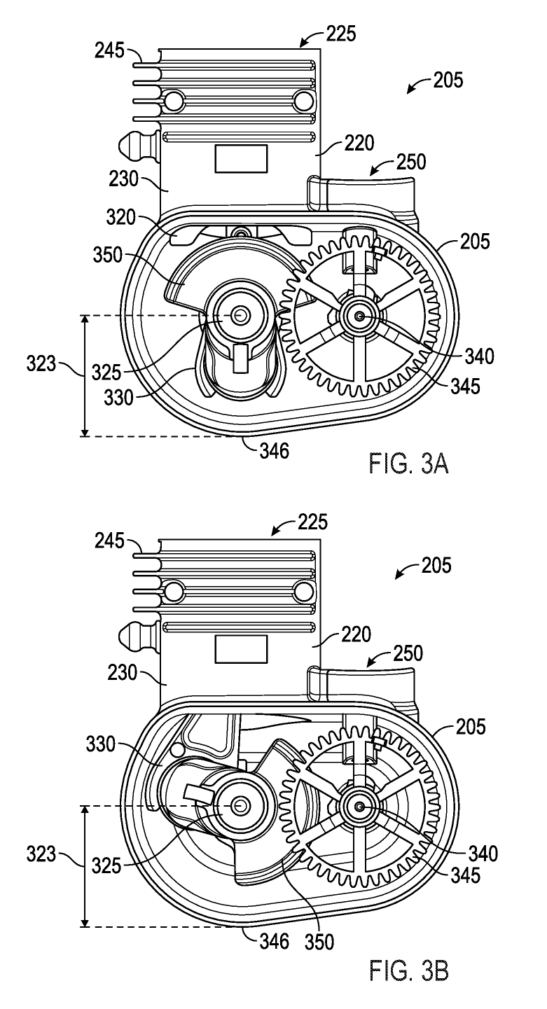

As shown in FIGS. 2-3B, the distance 341 between the between the center 343 of the crankshaft opening 321 (where the center 343 lies on the axis of rotation of the crankshaft 325) and at least a portion (an edge or other end point) of the outer surface 346 of the engine block is less than the standard minimum distance between the crankshaft axis and the horizontal mounting surface for a standard garden mounting flange for a horizontally-shafted engine. The distance 341 is measured radially outward from the center 343 to of the outer surface 346 of the engine block, not axially along the crankshaft's axis of rotation. The standard minimum distance is 4.25 inches for engines rated less than 6 horsepower. The standard minimum distance is 5.25 inches for engines rated 6 horsepower and above. By spacing an edge of the outer surface 346 the distance 341 away from the center 343 of the crankshaft opening 321, the geometry of the engine block 205 is such that the engine block itself will not physically prevent the engine 200 from being properly mounted in a horizontally-shafted orientation. The distance 341 ensures the necessary clearance between the outer surface 346 and the horizontal mounting surface. In a standard small air-cooled engine like engine 100 illustrated in FIG. 1, no edge of the outer surface of the engine block is less than the distance 341 and the physical structure of the engine block prevents the engine from being properly mounted in a horizontally-shafted orientation to a standard garden mounting flange for a horizontally-shafted engine. The length of the edge spaced apart from the center 343 may vary in different embodiments of the engine, but is sufficient to allow proper mounting in a horizontally-shafted orientation. The length of the edge may subtend an angle of at least 30 degrees between the center 343 and the ends of the length of the edge (e.g., 30 degrees, 45 degrees, 60 degrees, 75 degrees, 90 degrees, etc.). As illustrated in FIGS. 2-3B, the edge is located opposite the cylinder bore 225 and the length of the edge subtends an angle of at least 30 degrees. Other locations for the edge are possible, including for a slant bore or two cylinder engines. The engine 200 is able to be mounted in a vertically-shafted orientation via the apertures 235 of the crankcase cover 215.

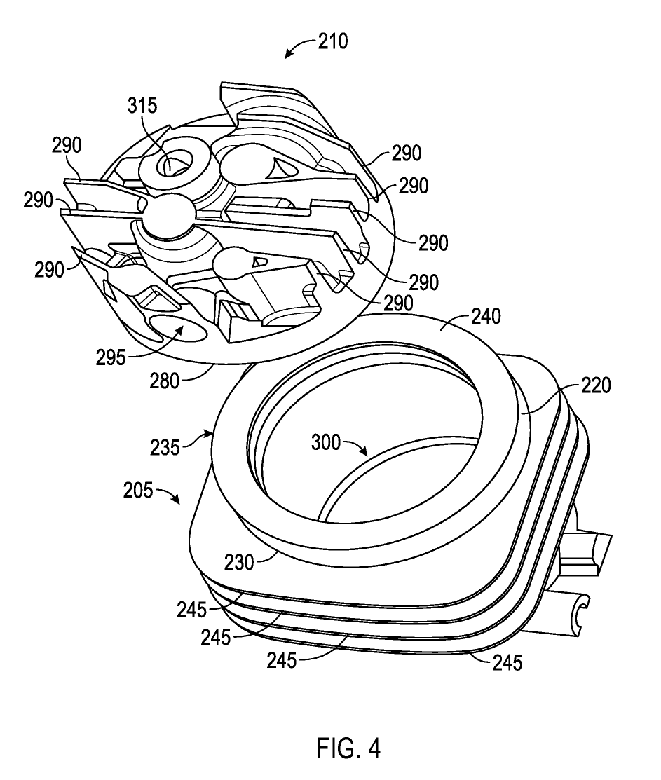

Referring to FIGS. 4-6, the cylinder head 210 includes an end face or mounting surface 280 having a cylinder wall thickness 285. In some embodiments, the cylinder wall thickness 285 is substantially constant. The mounting surface 280 is configured to mate with (e.g., engage, abut) the mounting surface 240 of the cylinder block 220 so that the cylinder head 210 may be welded to the cylinder block 220. The cylinder head 210 also includes one or more cooling fins 290. An intake port 295 and an exhaust port 300 are formed in the cylinder head 210. A valve seat is secured to the bottom of the cylinder head 210 at a valve seat mounting location 305, 310 around an aperture (e.g., opening) to each of the intake port 295 and the exhaust port 300. In some embodiments, the valve seats are welded to the cylinder head 210 (e.g., laser welded, friction welded, MIG welded, TIG welded). An aperture or opening 315 for receiving a spark plug is also formed in the cylinder head 210.

The mounting surfaces 280 and 240 of the cylinder head 210 and the cylinder block 220 may be configured such that the cylinder head 210 may be coupled to the cylinder block 220 with multiple orientations. For example, the mounting surfaces 280 and 240 may be configured such that the cylinder head 210 may be coupled to the cylinder block 220 at multiple discreet locations (e.g., four locations at 90° intervals) or may be configured such that the cylinder head 210 may be coupled to the cylinder block 220 at any orientation. In this way, the cylinder head 210 may be coupled to the cylinder block 220 in such a way to advantageously orient features, such as the intake port 295 and the exhaust port 300.

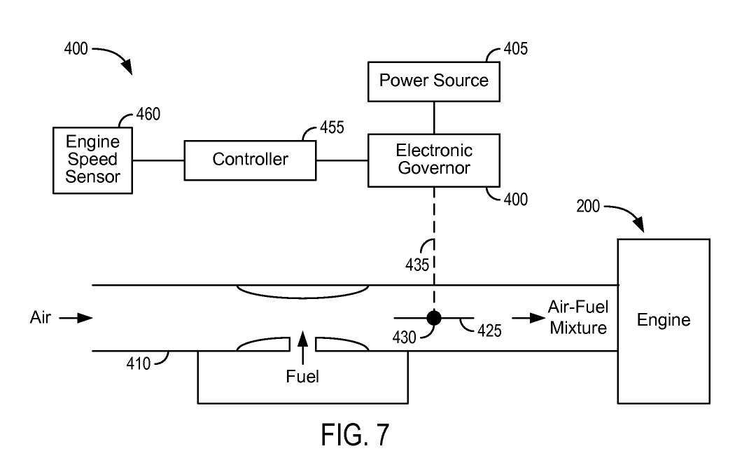

Referring to FIG. 7, the electronic governor 400 is illustrated according to an exemplary embodiment. The electronic governor 400 controls the speed of the engine 200 by controlling the position of a throttle valve 425 of a carburetor 410. In some embodiments, the electronic governor 400 is coupled to the throttle valve 425 by a throttle lever 430 and a linkage 435. In the carburetor 410, fuel is mixed with air to produce an air/fuel mixture for combustion in one or more cylinders of the engine 200. The throttle valve 425 controls the flow of the air/fuel mixture out of the carburetor 410 and in doing so controls the speed of the engine 200.

The electronic governor 400 is used to control the position of the throttle valve 425, thereby controlling the engine speed. The throttle valve 425 is movable between a closed position and a wide-open position. The position of the throttle valve 425 is adjusted so that the engine speed is maintained at a desired engine speed (e.g., the governed speed or the target engine speed). The desired engine speed can be a constant or can be varied controller in response to inputs from the engine (e.g., inputs related to engine load, desired output, or other engine operating conditions or objectives like providing an idle down operating mode in which the engine speed is lower when no load is applied to the engine than the operating engine speed when a load is applied to the engine).

An electrical power source 405 provides electrical power to the electronic governor 400 and other components (e.g. the controller 455). In some embodiments, the electrical power source 405 is a battery (e.g., a 12V battery, a lithium-ion battery, etc.) or other device that provides power to other components and systems of the engine or the vehicle or equipment powered by the engine 200. In some embodiments, the electronic governor 400 may have a dedicated electrical power source 405, such as a thermoelectric generator. A thermoelectric generator may be provided in a location such that one side is exposed to a relatively high temperature (e.g., near the engine block 205 to capture waste heat from the engine 200) and the opposite side is exposed to a relatively cool temperature (e.g., the surrounding air).

A controller 455 controls operation of the electronic governor 400. In some embodiments, the controller 455 also controls the operation of other components of the engine 200. An engine speed sensor 460 is coupled to the controller 455 to provide an engine speed input to the electronic governor 400. In some embodiments, the engine speed sensor 460 detects the engine speed using an ignition signal from an ignition system. For example, the positive sparks or pulses from the ignition system could be counted and used to determine the engine speed. In other embodiments, other appropriate engine speed sensors are utilized, such as a Hall-effect sensor that detects a magnet on the flywheel or other rotating component of the engine.

The controller 455 may include processing circuit, an input interface, and an output interface. The processing circuit includes a processor and memory. The processing circuit and processor are configured to receive inputs from an input interface (e.g., via a wired or wireless communication link with other components of the engine) and to provide an output (e.g., a control signal, an actuator output, etc.) via an output interface (e.g., via a wired or wireless communication link other components of the engine). The processing circuit can be a circuit containing one or more processing components (e.g., the processor) or a group of distributed processing components. The processor may be a general purpose or specific purpose processor configured to execute computer code or instructions stored in the memory or received from other computer readable media (e.g., CDROM, network storage, a remote server, etc.). The processing circuit may also include the memory. Memory may be RAM, hard drive storage, temporary storage, non-volatile memory, flash memory, optical memory, or any other suitable memory for storing software objects and/or computer instructions. When the processor executes instructions stored in the memory for completing the various activities described herein, the processor generally configures the computer system and more particularly the processing circuit to complete such activities. The memory may include database components, object code components, script components, and/or any other type of information structure for supporting the various activities described in the present disclosure. For example, the memory may store data regarding the operation of a controller (e.g., previous setpoints, previous behavior patterns regarding used energy to adjust a current value to a setpoint, etc.). According to an exemplary embodiment, the memory 510 communicably connected to the processor and includes computer code for executing one or more processes described herein and the processor is configured to execute the computer code.

Welding the cylinder head 210 to the engine block 205 eliminates the need for a head gasket (e.g., the head gasket 130). A head gasket is porous. During operation of an engine, oil is trapped in the pores of the head gasket (e.g., the gasket wicks oil from the cylinder bore into the gasket). This trapped oil is burned off during operation of the engine. Eliminating the head gasket eliminates this source of oil loss due to oil burn off, thereby reducing oil consumption, and improves emissions by eliminating this source of burnt oil. Despite being optimized to allow heat transfer therethrough, the head gasket acts as an insulator between the cylinder block and the cylinder head. Eliminating the head gasket therefore improves heat transfer between the cylinder block and the cylinder head by eliminating the insulative effect of the head gasket. Eliminating the head gasket also eliminates the need to service or replace the head gasket.

Welding the cylinder head 210 to the engine block 205 also eliminates cylinder bore distortion caused by the clamping force applied by the bolts used in a bolted connection between the cylinder block and the cylinder head in a standard small air-cooled engine (e.g., the engine 100).

Welding the cylinder head 210 to the engine block 205 allows the structure (e.g., the shape and mass) of these connections to be modified to utilize less material (e.g., less mass) than standard small air-cooled engines (e.g., the engine 100). This helps to reduce thermal distortion related to the substantial mass found at or near these connections in standard small air-cooled engines. The mass of material needed at this connection may be reduced (e.g., by eliminating the mounting locations 135, 140 of the engine 100). This reduction in material allows for an increase in the surface area of the external cooling fins (e.g., the cooling fins 245), by allowing the cooling fins to extend fully around the exterior of the cylinder bore, as opposed to the truncated cooling fins typically found on standard small air-cooled engines (e.g. the engine 100). The reduction in material and increased cooling fin surface area also reduces the thermal expansion as this connection, thereby reducing the likelihood of failure modes associated with thermal expansion. The reduction in material improves temperature distribution throughout the cylinder block and cylinder head assembly, thereby reducing hot spots during operation of the engine. The reduction in material also reduces cost and weight of the engine block and the cylinder head. In some embodiments, the reduction in material results in an engine that uses 1.3 pounds less aluminum than a standard small air-cooled engine. In some embodiments, the material used for the cylinder head is reduced by about 50%. The reduction in material also allows inlet port of the cylinder head to be positioned closer to the periphery of the cylinder head than in a cylinder head for a standard small air-cooled engine. This positioning of the inlet port keeps the incoming air cooler and more dense.

Welding the cylinder head 210 to the engine block 205 allows for the elimination of push rod guide tubes from the engine block and allows for use of external guide tubes (e.g., the push rod housing 260). Eliminating the push rod guide tubes from the engine block removes the need for the material surrounding the guide tubes and allows for greater flexibility in the placement of the valve ports in the cylinder head.

Welding the crankcase cover 215 to the engine block 205 eliminates the need for a crankcase gasket (e.g., the crankcase gasket 197). This provides similar advantages to welding the cylinder head 210 to the engine block 205, including eliminating a possible leak point and reducing the amount of material used at this connection. Welding the crankcase cover 215 to the engine block 205 also allows for the elimination of the lubricant inlet or oil fill tube for providing oil to the crankcase and the dipstick that is typically inserted into the oil fill tube to both seal the tube and provide a user with an indication of the oil level in the crankcase. Eliminating these components reduces manufacturing and supply costs because the oil fill tube does not need to be formed and the dipstick does not need to be provided.

Welding the cylinder head 210 to the engine block 205 and welding the crankcase cover 215 to the engine block 205 allows for the engine 200 or the engine block 205 to be “substantially sealed.” Such a “substantially-sealed engine” or “substantially-sealed engine block” does not include a head gasket, does not include a crankcase gasket, or does not include both a head gasket and a crankcase gasket. A “substantially-sealed engine” or a “substantially-sealed engine block” may include some gaskets like a valve cover gasket sealing the valve cover to the cylinder head, an exhaust gasket sealing an exhaust pipe or muffler to the exhaust port, and/or gaskets sealing the push rod tubes (e.g., push rod tubes 265, 270) to the engine block and cylinder head, but the cylinder bore and the crankcase are permanently sealed (e.g., not accessible without destructively opening the cylinder bore and/or the crankcase). A substantially-sealed engine or engine block reduces user maintenance by eliminating or reducing the need to change the oil in the engine 200. In some embodiments, the oil in the engine 200 is never changed. A substantially-sealed engine can be filled with oil at the factory or dealer and then sealed, eliminating the possibility of a user not filling the engine with oil before starting the engine for the first time. The engine oil does not need to be changed because the possible leak points have been eliminated and the engine is able to operate at a lower engine oil temperature. The lower temperature slows or prevents oil breakdown as compared to standard small air-cooled engines (e.g., the engine 100).

Because the engine 200 or the engine block 205 is substantially sealed by the welding of the cylinder head 210 to the engine block 205 and the welding the crankcase cover 215 to the engine block 205 and the engine speed is controlled with the electronic governor 400, the mechanical governor, as well as components of the engine 200 associated with the maintenance of the oil may be eliminated, including the dipstick and the oil fill tube.

The reduced size of the engine 200 provides several benefits. The smaller size of the engine 200, as well as the substantially sealed engine block 205 allows the engine 200 to be oriented in either a vertical crankshaft orientation or a horizontal crankshaft orientation. The engine 200 may be oriented in a vertical crankshaft orientation for example, for a push lawnmower, a lawn tractor, or a pressure washer. The engine 200 may be oriented in a horizontal crankshaft orientation for example, for a log splitter, a generator, agricultural equipment, or a pressure washer.

Further, the smaller engine volume and lower weight can aid in the shipping and storage of the engine 200. The mass of the engine 200 may be substantially less than a conventional engine. For example, a standard sized shipping pallet may be capable of accommodating 120 of the engines 200, in comparison with only 96 conventionally constructed engines like the engine 100.

The construction and arrangement of the apparatus, systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

Although the figures may show or the description may provide a specific order of method steps, the order of the steps may differ from what is depicted. Also two or more steps may be performed concurrently or with partial concurrence. Such variation will depend on various factors, including software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A small air-cooled internal combustion engine, comprising:
an aluminum engine block including:
a cylinder,
a crankcase reservoir, and
an outer surface;
a piston positioned within the cylinder and configured to reciprocate within the cylinder; and
a crankshaft coupled to the piston and configured to rotate about a crankshaft axis, wherein a portion of the crankshaft is located in the crankcase reservoir;
wherein the outer surface of the engine block has an edge located a radial distance from the crankshaft axis and the radial distance is less than a standard minimum distance between the crankshaft axis and a horizontal mounting surface for a standard garden mounting flange for a horizontally-shafted engine.

2. The small air-cooled internal combustion engine of claim 1, wherein the standard minimum distance is 4.25 inches.

3. The small air-cooled internal combustion engine of claim 1, wherein the standard minimum distance is 6 inches.

4. The small air-cooled internal combustion engine of claim 1, wherein the engine block does not include a lubricant inlet that allows a user to add lubricant to the crankcase reservoir.

5. The small air-cooled internal combustion engine of claim 1, wherein a mechanical governor is not located in the crankcase reservoir.

6. The small air-cooled internal combustion engine of claim 1, further comprising:
an electronic governor for controlling engine speed.

7. The small air-cooled internal combustion engine of claim 1, wherein in a first working orientation, the crankshaft is arranged vertically, and, wherein in a second working orientation, the crankshaft is arranged horizontally.

8. The small air-cooled internal combustion engine of claim 1, wherein the engine does not include a dipstick for measuring a lubricant level within the crankcase reservoir.

9. The small air-cooled internal combustion engine of claim 1, wherein the cylinder comprises an aluminum cylinder block and an aluminum cylinder head welded to the cylinder block.

10. A small air-cooled internal combustion engine, comprising:
a substantially-sealed aluminum engine block including:
a cylinder, and
a crankcase reservoir,
wherein a mechanical governor is not located in the crankcase reservoir;
a piston positioned within the cylinder and configured to reciprocate within the cylinder; and
a crankshaft coupled to the piston and configured to rotate about a crankshaft axis, wherein a portion of the crankshaft is located in the crankcase reservoir.

11. The small air-cooled internal combustion engine of claim 1, wherein the engine block does not include a lubricant inlet that allows a user to add lubricant to the crankcase reservoir.

12. The small air-cooled internal combustion engine of claim 10, further comprising:
an electronic governor for controlling engine speed.

13. The small air-cooled internal combustion engine of claim 10, wherein in a first working orientation, the crankshaft is arranged vertically, and, wherein in a second working orientation, the crankshaft is arranged horizontally.

14. The small air-cooled internal combustion engine of claim 10, wherein the engine does not include a dipstick for measuring a lubricant level within the crankcase reservoir.

15. The small air-cooled internal combustion engine of claim 10, wherein the cylinder comprises an aluminum cylinder block and an aluminum cylinder head welded to the cylinder block.

16. The small air-cooled internal combustion engine of claim 10, wherein the engine block includes an outer surface having an edge located a radial distance from the crankshaft axis and the radial distance is less than a standard minimum distance between the crankshaft axis and a horizontal mounting surface for a standard garden mounting flange for a horizontally-shafted engine.

17. The small air-cooled internal combustion engine of claim 16, wherein the standard minimum distance is 4.25 inches.

18. The small air-cooled internal combustion engine of claim 16, wherein the standard minimum distance is 6 inches.
